(19) United States
(12) Patent Application Publication
(10) Pub. No.: US 2003/0133638 A1
(43) Pub. Date: Jul. 17, 2003

(54) Ion implanted lithium niobate modulator with reduced drift

(76) Inventors: Sungho Jin, Millington, NJ (US); Yiu-Man Wong, Wescosville, PA (US); Wei Zhu, Warren, NJ (US); Christopher A. Bower, New Providence, NJ (US)

Correspondence Address: HARNESS, DICKEY & PIERCE, P.L.C., P.O. BOX 8910, RESTON, VA, 20195, US

(21) Appl. No.: 10/050,656

(22) Filed: Jan. 16, 2002

(51) Int. Cl. G02F 1/035

(52) U.S. Cl. 385/2

(57) ABSTRACT

An electrooptic device and method for making the same, including one or more of substrate, a buffer layer, a charge dissipation layer, and electrodes are disclosed. Active ions, such as F⁻ ions, are implanted the buffer layer. The active ions react with positive ions, such as Li⁺ from the substrate to form stable compounds such as LiF. The reduced number of mobile Li⁺ ions reduces the DC drift of the associated electrooptic device. The profile of the implanted ions may be adjusted to control and/or optimize the properties of the electrooptic device. Fluorine is particularly advantageous because it also lowers the dielectric constant, thereby facilitating higher frequency operation.

### TECHNICAL FIELD

The present invention relates to waveguide type optical devices, in particular, lithium-niobate-based, high-speed optical signal modulators and methods of making the same.

### BACKGROUND ART

Waveguide optical devices may utilize an electro-optical crystal, such as an LiNbO₃ or an LiTaO₃ substrate in order to modulate optical signals for high-speed telecommunication systems using optical fiber networks. For optical modulators, an electric field is applied to an optical waveguide path formed inside a surface of an electro-optical crystal substrate such as LiNbO₃ or LiTaO₃, which in turn alters the refractive index of the optical waveguide path inducing switching of optical signals traveling inside the optical waveguide path, as well as modulates the phase and intensity of the optical signals. FIG. 1(a) schematically illustrates a cross-sectional diagram of such a single drive LiNbO₃ modulator device 100. The voltage V applied to the two electrodes 10, 12 separated by a gap G produces an electric field line E, which intersects the optical waveguide path 14.

In a single drive LiNbO₃ modulator device, such as the one illustrated in FIG. 1(a), a transparent dielectric film or buffer layer 16, having a slightly lower refractive index than that of the optical waveguide path 14, is often sandwiched between the optical waveguide path 14 and the electrodes 10, 12. The buffer layer 16 reduces the undesirable absorption of light in the optical waveguide path 14 by the electrode metal, and also helps to match velocities between the RF and optical signals because of the buffer layer's lower dielectric constant. When an electrode 10, 12 is formed on the buffer layer 16 and the voltage V is applied to the electrode 10, 12, the electric field E is applied to the optical waveguide path 14 formed in the LiNbO₃ crystal substrate 18 and the refractive index of the optical waveguide path 14 changes in proportion to the intensity of the electric field E. As a result, functions, such as switching and modulation of optical signals may be performed. Therefore, accurate control of the electric field E applied to the optical waveguide path 14 is important in assuring reliability of devices 100 of this type.

Waveguide devices utilizing the above-described electric field-based modulation of an electro-optical crystal substrate include optical switches, modulators, branching filters, and polarized wave controllers. Such devices are described, for example, in “Optical Fiber Telecommunications”, Volume IIIB, edited by I. P. Kaminow and T. L. Koch, page 404, Academic Press, New York, 1997, and “Lithium Niobate for Optoelectronic Applications” by J. Saulner, Chap. CII in Materials for optoelectronics, edited by Maurice Quilec, 1996.

FIG. 1(b) illustrates an exemplary dual drive prior art LiNbO₃ modulator device 200. The device 200 is based on a Mach-Zehnder-type optical modulator design which is useful for ultra-high speed optical communication. The modulator device 200 is a dual-drive, traveling wave, y-branch type design, which is desirable for ensuring high modulation bandwidth and a low drive voltage operation. The modulator 200 of FIG. 1(b) allows an electrical drive signal to propagate from input optical fiber 1, along a transmission line along a direction of the optical waveguide path 14, to optical output fiber 9. One or both of the input optical fiber 1 and the optical output fiber 9 may be surrounded by a glass capillary 8. The electrodes 10, 12 may be made of gold strips and the buffer layer may be a sputter deposited SiO₂ layer.

A long interaction length enables the drive voltage V to be kept relatively low. A thin charge-dissipating-layer (CDL layer) including a slightly conductive material (possibly Si, nitride or oxide compound-based may optionally be added between the electrode 10, 12 and the buffer layer 16 so as to reduce the electric charge accumulation/drift on the buffer layer 16 surface, which can cause electric field control variations.

In FIG. 1(b), the LiNbO₃ crystal substrate 18 is cut along a certain crystallographic orientation, e.g., x-axis or z-axis, depending on the mode of operation and specific application. If the cut is made in such a manner that an x-axis of the crystal axis extends in a longitudinal direction of a chip and a z-axis extends in the direction of thickness, then the desirable electro-optical coefficient x₃₃ is utilized. A semi-circular optical waveguide path 14 having a greater refractive index than that of the substrate 18 and having a diameter of typically several micrometers (similar to the core size of optical fibers 1,9) is formed on a surface of the substrate 18 by either localized ion implantation of titanium or by deposition of Ti metal and controlled thermal diffusion into the waveguide regions.

FIG. 1(c) schematically illustrates a prior art modulator structure of a single drive type, which includes an LiNbO₃ substrate 18, a buffer oxide layer 16, a charge dissipation layer 17, an optical waveguide 14, and electrodes 10, 12. For the purpose of preventing absorption of light propagating through the optical waveguide path 14 by the electrode 10, 12, the silicon dioxide (SiO₂) layer 16 having a specific dielectric constant of ˜4.0 and a refractive index of about ˜1.45 is deposited to a thickness of e.g., ˜0.5 micrometers over the entire surface of the waveguide substrate 18 by a film formation technique, such as sputtering or electron beam deposition, thereby forming the buffer layer 18. The signal electrode 10 and a ground electrode 12 including a thin gold (Au) film having a width of several micrometers and a thickness of ˜10 micrometers, for example, are formed by vacuum deposition and plating at positions on the surface of the buffer layer 16 corresponding to the optical waveguide path 14. As illustrated, the output optical fiber 9 may be aligned and locked in position by glass capillary fixture 8.

In operation, the voltage V applied to the waveguide path 14 may change with time. As a result, the characteristics of the outgoing light signal from the modulator device 100 also varies with time. Such a phenomenon is referred to as a “DC drift” problem in LiNbO₃ waveguide devices.

This common and undesirable, time-dependent drift of the DC bias voltage should be either eliminated or minimized. Movement of ions, such as the Li⁺ ions or Na ions, that are present inside the LiNbO₃ crystal 18 or on its surface as interstitial atoms, is considered to be one of the causes of DC drift. As the ions move or accumulate locally, the distribution of the DC electric field within the modulator device 100 changes over time and DC drift occurs. This is described in S. Yamata et al., “DC Drift Phenomenon in LiNbO3 Optical Waveguide Devices”, Japanese Journal of Applied Physics Vol. 20, No. 4, April 1881, page 733.

There are several known solutions to this problem, many focusing on immobilizing the movable ions inside and on the surface of the crystal substrate 18 in order to control DC drift. Some of these known solutions are described below.

U.S. Pat. No. 5,680,497 discloses an optical waveguide device which includes a LiNbO₃ substrate 1 and a buffer layer 3′. The buffer layer 3′ is made of a transparent dielectrical insulator of a mixture between silicon dioxide and an oxide of at least one element selected from the group consisting of the metal elements of the Groups III-VIII, Ib, and IIb elements, for example, about 5-10 atomic % of In₂O₃. The doping of the SiO₂ buffer layer with other oxides such as In₂O₃ appears to help tie up or slow down the movement of the Li⁺ ions. U.S. Pat. No. 5,479,552 discloses a waveguide-optical device which includes an LiNbO₃ or LiTaO₃ substrate, a blocking layer, and buffer layer of SiO₂. The blocking layer, including Si, Si₃N₄, SiON, or MgF₂ is placed between the substrate and the buffer layer. The blocking layer blocks the diffusion of Li⁺ ions from the substrate.

Japanese Kokai Patent Application No. Hei 6-75195 discloses an optical controller including an LiNbO₃ or LiTaO₃ substrate and a SiO₂ buffer. A blocking layer, of low ionic conductance, is also placed between the substrate and the buffer. Again, the blocking layer may include Si, Si₃N₄ and MgF₂. The trapping layer includes SiO₂ doped with phosphorus. The trapping layer and blocking layer may be used separately or in combination to thereby sandwich the buffer layer.

Japanese Kokai Patent Application No. HEI 5-113513 discloses a waveguide optical device which includes an LiNbO₃ substrate doped with a Group V element, such as Cl and/or P.

“Reduction of DC Drift in LiNbO₃ Waveguide Electro-optic Device by Phosphorus and SiO₂ Buffer Layer” by Suhara et al. discloses a LiNbO₃ substrate with a buffer layer of SiO₂ doped with phosphorus.

### SUMMARY OF THE INVENTION

The present invention reduces DC drift in conventional electrooptic devices by providing an electrooptic device and method for making the same, wherein active ions, such as F⁻ ions, are implanted in a buffer layer. In a preferred embodiment, the active ions react with positive ions, such as mobile Li⁺ to form stable compounds such as LiF. The reduced number of mobile Li⁺ ions reduces the DC drift of the associated electrooptic device.

More specifically, the ion implantation of F⁻ ions or fluorine containing species is performed in a buffer layer, such as a SiO₂ which may be doped with other oxides such as In₂O₃ buffer layer The F⁻ ions or fluorine containing ions getter positive ions, such as lithium in the buffer layer. Further, the profile of the implanted ions may be adjusted to control and/or optimize the properties of the electrooptic device. Fluorine is particularly advantageous because it also lowers the dielectric constant, thereby facilitating higher frequency operation.

### BRIEF DESCRIPTION OF THE DRAWINGS

The nature, advantages and various additional features of the invention will appear more fully upon consideration of the illustrative embodiments now to be described in detail with the accompanying drawings. In the drawings:

FIGS. 1(a), (b), and (c) schematically illustrate the basic structure and operation principle of prior art single and dual drive LiNbO₃ modulators;

FIGS. 2(a) and (b) schematically illustrate cross-sectional diagrams depicting (a) a fluorine ion implanted modulator structure of a single drive type according to the present invention and (b) a fluorine implanted modulator of a dual-drive type according to the present invention;

FIG. 3 illustrates an F⁻ ion depth profile of ion implantation into an Sio₂ buffer layer;

FIGS. 4(a)-(c) schematically illustrate alternative embodiments of the F⁻ ion implanted LiNbO₃ modulator structure according to the present invention;

FIG. 5 schematically illustrates yet another embodiment of the present invention.

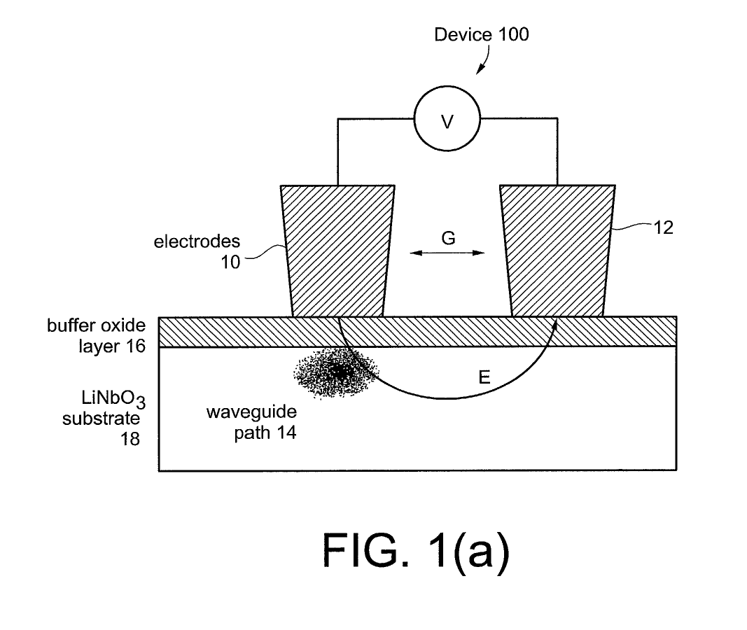

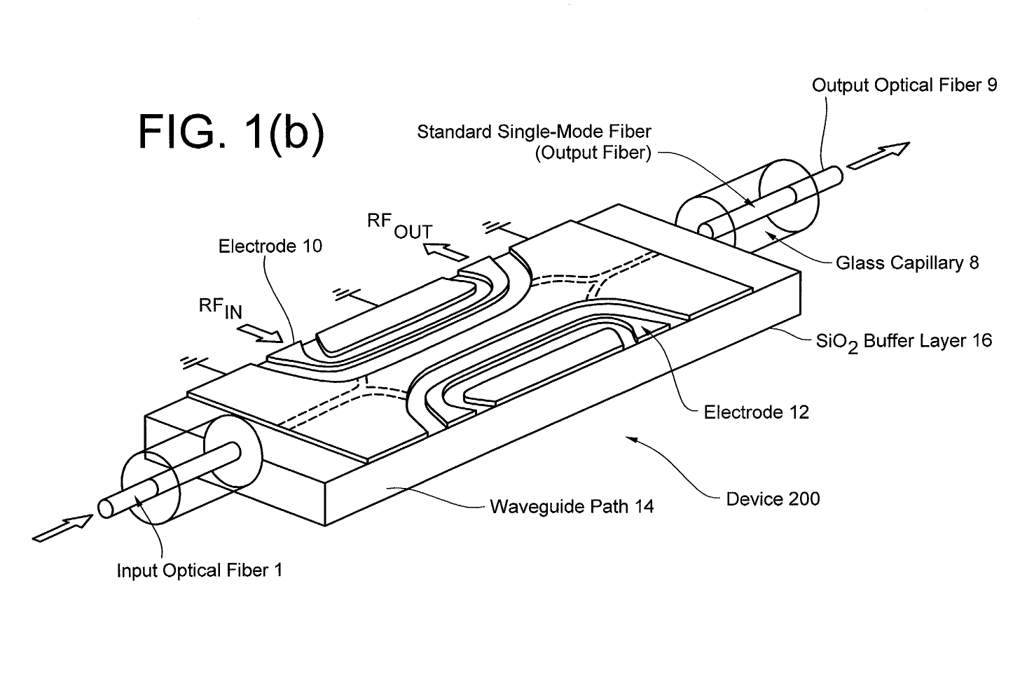

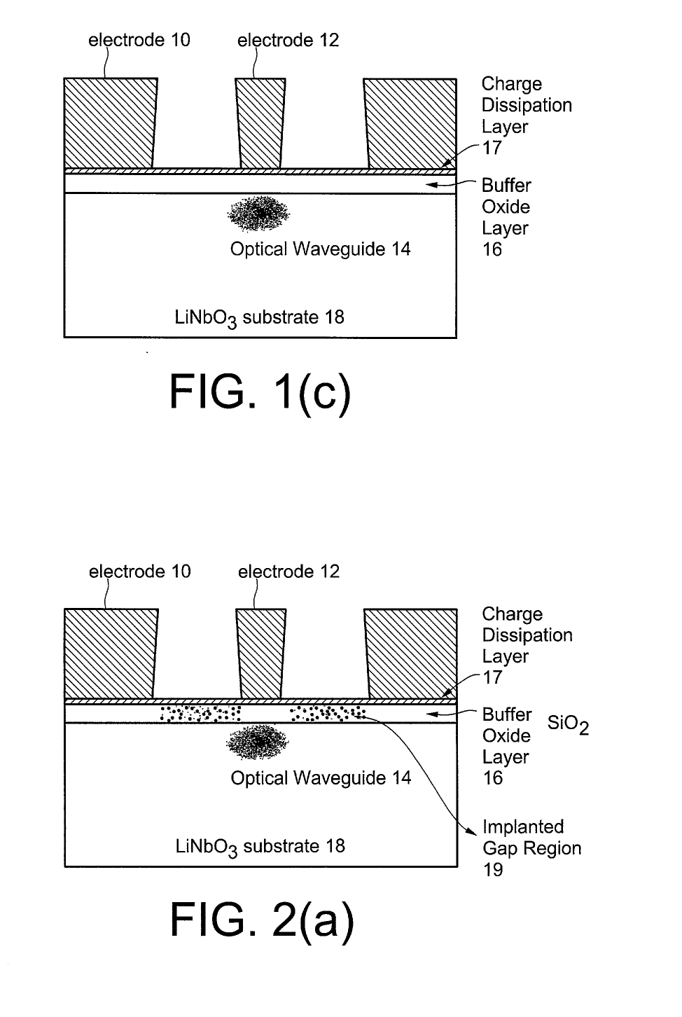

It is to be understood that the drawings are for purposes of illustrating the concepts of the present invention and are not to scale.

### DETAILED DESCRIPTION OF THE PREFERRED EMBODIMENTS

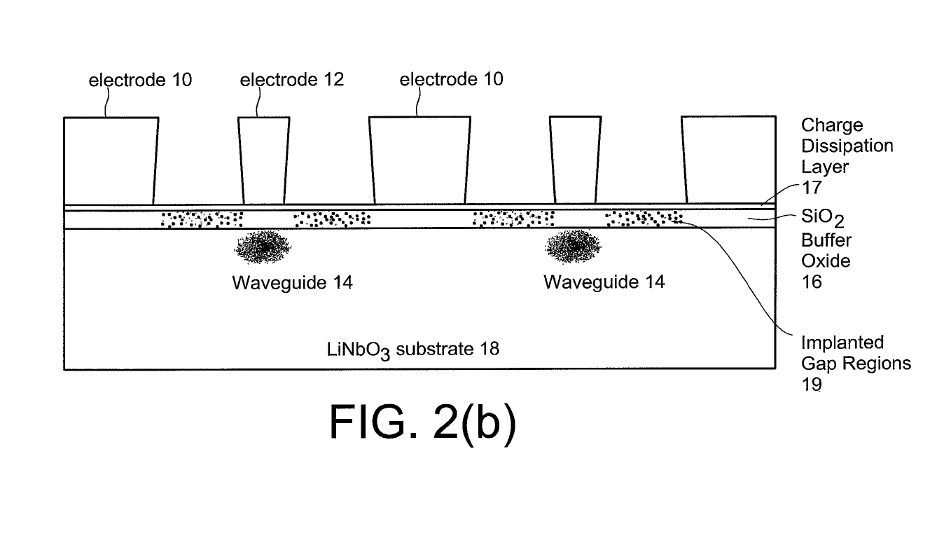

Referring to the drawings, FIG. 2(a) schematically illustrates a fluorine ion (F⁻) implanted modulator structure of a single drive type according to the present invention. According to the present invention, fluorine ions (F⁻) are incorporated, in a blanket manner, onto the finished modulator parts with the electrode structure already formed. The implanted fluorine ions (F⁻) get into the SiO₂ buffer layer 16 by penetrating the charge-dissipating layer 17 at sufficiently high ion implantation accelerating energy, and tie up mobile ions such as Li⁺ or Na⁺ in the SiO₂ buffer layer 16 and reduce the DC voltage drift problem. For the particular case of FIGS. 2(a) and (b) type device configurations, the fluorine ions (F⁻) are implanted only in the buffer layer 16 locations between the electrodes 10, 12 (in the implanted gap regions 19).

The fluorine atoms (F⁻) so introduced serve at least two functions. The first is to trap mobile ions such as Li⁺ or Na⁺ especially those remaining mobile ions which may not have been controlled by other means such as the use of the SiO₂ buffer layer 16 doped with In₂O₃ and other materials. The second is to actually reduce the dielectric constant (ε) in the F⁻ implanted gap regions of the SiO₂ buffer layer 16, and thus enhancing the electric field concentration under the electrode 10, 12 so as to increase the effective field of the waveguide region. The desired level of dielectric constant reduction is, for example, from 4.0 to 3.8, or from 4.0 to 3.6 if an F⁻0 concentration as high as 7% is introduced.

The introduction of fluorine ions (F⁻) into the SiO₂ buffer layer 16 (undoped or doped with indium oxide), according to the present invention, ties up the mobile Li⁺ and other ions and reduces the DC bias voltage drift. When Li⁺ and F⁻ atoms are present together, they form a very stable compound, LiF, due to a strong thermodynamic driving force. The heat of formation (ΔH_{f}) for the reaction of Li⁺ and F⁻ to produce LiF is a very large negative value, i.e., about −290 Kcal/mole at 0° K. This is much greater than the ΔH_{f} values for the formation of SiF₄ (−185 Kcal/mole) or InF₃ (−167 Kcal/mole). Thus the tendency of LiF formation and an Li⁺ ion gettering effect using fluorine is very strong. Further, once the LiF compound is formed, it is difficult to separate the Li⁺ from the LiF compound, thus the previously mobile Li⁺ ions are converted to immobile or significantly less mobile ions.

After implantation of fluorine atoms, the buffer layer 16 may be optionally and preferably baked to facilitate the Li—F reaction to form LiF. The preferred temperature and time of such baking is 100-700° C., preferably 100-500° C., and for a duration of 0.1-1000 hours, preferably 0.5-50 hours. The atmosphere for such baking treatment can be oxygen, air or inert gas, such as argon.

In the exemplary embodiment of FIG. 2(a), the LiNbO₃ substrate 18 is a single crystal z-cut substrate, approximately 700 μm high, where n=2.14, ε_{zz}=30, and r₃₃=31 pm/V, the SiO2 buffer oxide layer 16 is approximately 1 mm thick and indium doped, where n=1.45 and ε=4, the charge dissipation layer 17 is approximately 80 nm thick, the electrode 10 is a gold ground electrode, 15-30 μm high, the electrode 12 is a gold hot line electrode, 15-30 μm high, 6-10 μm wide, and 15-30 μm from the ground electrode 10., and the optical waveguide path 14 is Ti diffused, where n=2.15 and the loss is approximately 0.2 dB/cm, however, all of these parameters could be varied or applied to other embodiments of the present invention, as would be know to one of ordinary skill in the art.

Further, the fluorine ions (F⁻) may be incorporated in either a single drive type or a dual drive type modulator. FIG. 2(a) illustrates a single drive type modulator and FIG. 2(b) illustrates a dual drive type modulator. As illustrated in FIG. 2(b), the dual drive type modulator includes multiple waveguides 14.

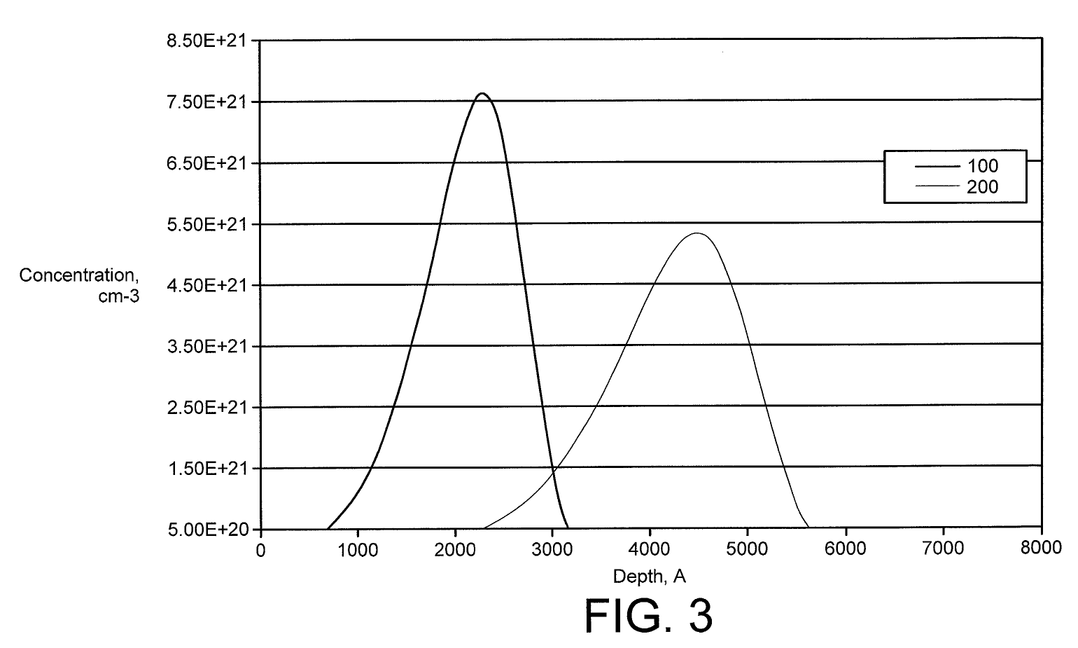

The desired dose and ion implantation energy of F⁻ ions varies depending on the amount of mobile Li⁺ ions present, the degree of Li⁺ ion gettering, the thickness of the SiO₂ buffer layer 16, etc. FIG. 3 illustrates the depth profile of implanted fluorine atoms in SiO₂ shown as a function of the position in the thickness of the SiO₂ buffer layer being implanted with fluorine. FIG. 3 is an example for the case of F⁻ ion implantation dose of 10¹⁷ ions/cm² for two different implantation energies (accelerating voltage) of 100 KeV and 200 KeV. For the given dose and 100 KeV energy, the peak in fluorine concentration occurs at a depth of ˜1300 A in SiO₂, with a fluorine concentration of ˜8.3×10²¹ atoms/cm³ (corresponding to approximately 30 atomic % concentration). For lower doses, the concentration of implanted fluorine in the SiO₂ buffer layer decreases substantially proportionately.

FIG. 3 also illustrates that a higher accelerating energy of implantation increases the average penetration depth more or less proportionately. For a thinner SiO₂ buffer layer, lower accelerating fields may be used for smaller penetration depths. For a thicker buffer layer, a higher accelerating field may be used or multiple implantation steps with different accelerating fields, so that the various implantation depths can be superimposed to distribute the implanted fluorine atoms over more volume of the buffer layer.

For reducing the DC bias voltage drift in LiNbO₃ modulator type applications, the desired accelerating field for F⁻ ion implantation is in the range of 5-500 KeV, preferably 20-200 KeV. The desired dose for the F-ion implantation process is 0.1-1×10¹⁶ ions/cm², preferably 0.4-3×10¹⁶ ions/cm². The desired final concentration of implanted F⁻ atoms in SiO₂ is in the range of 0.1-20 atomic %, preferably in the range of 0.2-2 atomic %. The distribution of implanted F⁻ atoms along the buffer layer thickness can be non-uniform as shown in FIG. 3, or can be spread more uniformly, as might be anticipated for the post-implantation baked example.

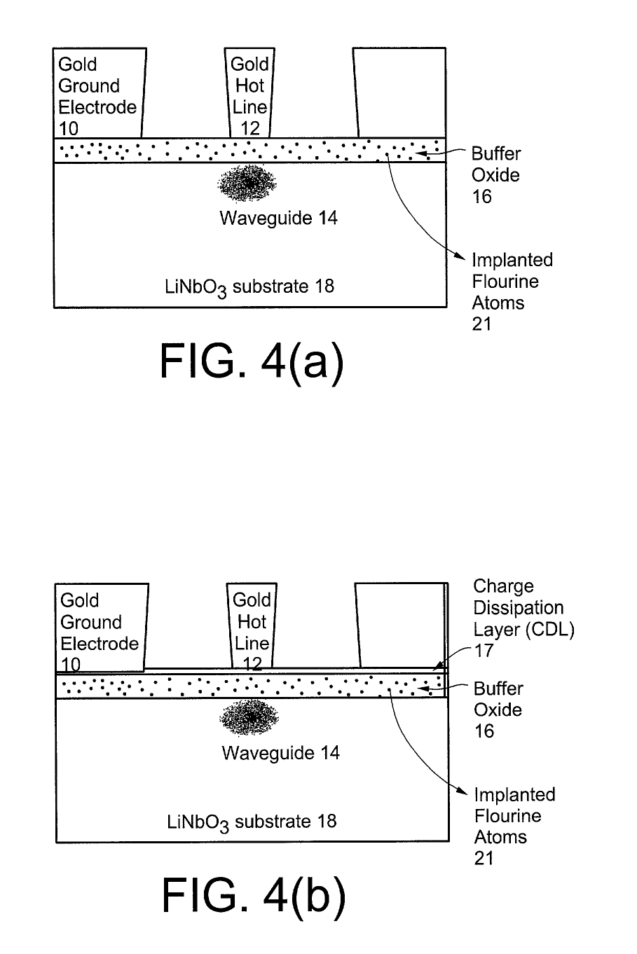

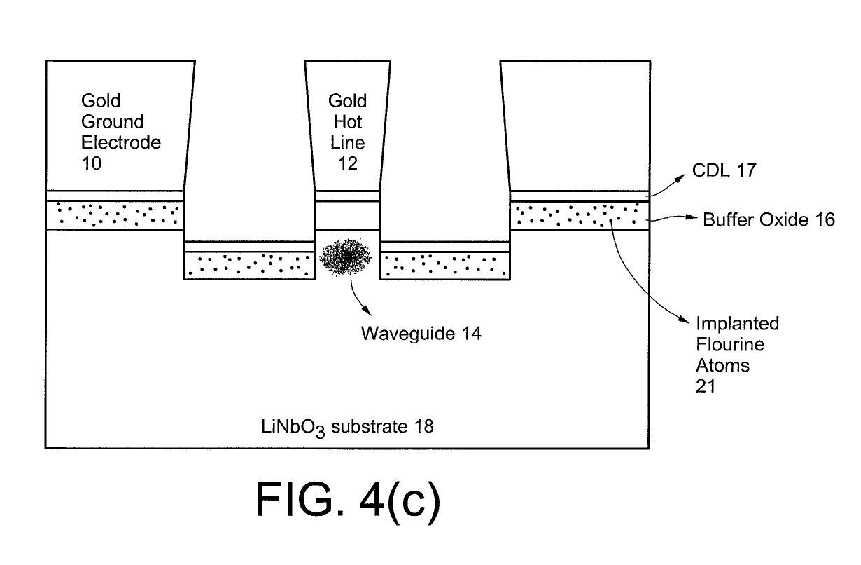

FIG. 4(a) is an alternative embodiment of a fluorine implanted modulator structure according to the present invention. In this embodiment, a blanket implantation of F⁻ ions 21 is carried out on the upper portion of SiO₂ buffer layer 16, before the electrodes 10, 12 are added. Either the as deposited (e.g., by sputtering) or the deposited and annealed (e.g., 600° C. for 5 hours in wet oxygen atmosphere to reduce defects in the asdeposited microstructure and optimize the structure, dielectric and optical properties of the SiO₂) buffer layer 16 can be ion implanted. If implanted onto the asdeposited SiO₂, the subsequent buffer layer annealing treatment can also serve as a facilitating treatment for Li⁺ and F⁻ interaction to form the LiF compound. The electrodes 10, 12 (e.g., gold stripes deposited and patterned) are then formed on the surface of the implanted buffer layer 16.

FIG. 4(b) represents an alternative embodiment in which a charge-dissipating-layer (CDL) 17 (for example, a thin layer of a very slightly conductive material such as a mixture of Si and TiN) is added between the ion implanted buffer layer 16/21 and the electrodes 10, 12. This CDL 17 serves to reduce undesirable and uncontrolled electric charge accumulation and movement, thus ensuring reproducible behavior during electro-optic operations. The implantation can be performed before the charge-dissipating-layer 17 is deposited, or alternatively, after the CDL layer 17 is deposited, by utilizing higher accelerating voltage and making the implanted ions penetrate into the buffer layer 16 beyond the thickness of the charge-dissipating-layer 17.

The inventive F⁻ ion implantation approach of the present invention can also be applied to other configurations of LiNbO₃ modulators, such as the one depicted in FIG. 4(c). In this configuration, part of the base LiNbO₃ substrate 18 is selectively etched or ion milled in such a way that a ridge configuration results. The presence of grooves between the electrodes 10, 12 serves to minimize Li⁺ ion transport by removing the material along the part of the electric field lines emanating from one electrode 10 toward the adjacent electrode 12, and lowers the effective dielectric constant which improves the matching of RF signal and optical signal. The accompanying decrease in the line capacitance also allows a reduction in the buffer layer 16 thickness for enhanced RF-optical signal matching. As in the case of FIG. 4(a), the implantation can be carried out before the electrodes are deposited.

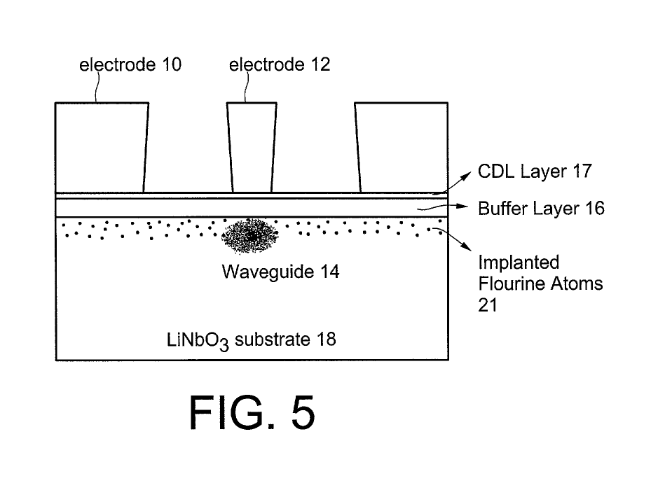

Yet another embodiment of the present invention is schematically illustrated in FIG. 5. In this case, the F⁻ ion implantation is carried out on the surface of the LiNbO₃ substrate 18 before the buffer layer 16 and the electrodes 10, 12 are formed. Here, the implanted F⁻ ions combine with the Li⁺ in the substrate 18 and forms a stable LiF compound which can serve as a barrier to slow down or stop the movement of mobile Li⁺ ions toward the buffer layer 16 above.

It is noted that the voltage drift of electrooptic devices made in accordance with one or more embodiments of the present invention is reduced by at least a factor of 2, or more preferably by at least a factor of 5, over electrooptic devices without implanted F⁻ ions, when the voltage drift is measured over a period of at least of one month at ambient temperature or at least 24 hours at an accelerating test temperature of 100° C.

It is understood that the above-described embodiments are illustrative of only a few of the many possible specific embodiments which can represent applications of the invention. It is further understood that various combinations of features of the above exemplary embodiments, although not expressly set forth, are also within the knowledge of one of ordinary skill in the art. Further, numerous and varied other arrangements can be made by those skilled in the art without departing from the spirit and scope of the invention.

In the claims:

1. A process for manufacturing an electrooptic device, comprising:
depositing a buffer layer on a substrate with a waveguide therein;
forming at least two electrodes on top of the buffer layer; and
implanting F⁻ ions in the buffer layer.

2. The process of claim 1, further comprising:
baking, after depositing the buffer layer on the substrate to facilitate diffusion and combining of Li⁺ ions and the F⁻ ions.

3. The process of claim 1, wherein the electrode forming step is performed before the F⁻ implanting step.

4. The process of claim 3, wherein the F⁻ ions are implanted between the at least two electrodes.

5. The process of claim 3, further comprising:
depositing a charge dissipation layer on the substrate prior to the electrode forming step.

6. The process of claim 5, further comprising:
etching the substrate prior to the charge dissipation layer depositing step.

7. The process of claim 3, wherein the substrate is made of one of LiNbO₃ or LiTaO₃.

8. The process of claim 1, wherein the F⁻ ion implanting step is performed before the electrode forming step.

9. The process of claim 8, wherein the F⁻ ions are implanted between the at least two electrodes.

10. The process of claim 8, further comprising:
depositing a charge dissipation layer on the substrate prior to the electrode forming step.

11. The process of claim 10, further comprising:
etching the substrate prior to the charge dissipation layer depositing step.

12. The process of claim 8, wherein the substrate is made of one of LiNbO₃ or LiTaO₃.

13. An electrooptic device, comprising:
a substrate with a waveguide therein, formed of an electrooptic material;
a buffer layer, on top of said substrate;
at least two electrodes on top of said buffer layer;
wherein F⁻0 ions are implanted in said buffer layer.

14. The device of claim 13, wherein the fluorine concentration in said buffer layer is at least 0.1%.

15. The device of claim 13, wherein the fluorine concentration in the said buffer layer is preferably in the range of 0.2-2%.

16. The device of claim 13, wherein said buffer layer is annealed.

17. The device of claim 13, wherein voltage drift of said electrooptic device is reduced by at least a factor of 2, when the voltage drift is measured over a period of at least of one month at ambient temperature or at least 24 hours at an accelerating test temperature of 100° C.

18. The device of claim 17, wherein voltage drift of said electrooptic device is reduced by at least a factor of 5, when the voltage drift is measured over a period of at least of one month at ambient temperature or at least 24 hours at an accelerating test temperature of 100° C.

19. The electrooptic device of claim 13, wherein said F⁻ ions are implanted in the buffer layer between the at least two electrodes.

20. The electrooptic device of claim 13, further comprising:
a charge dissipation layer between said buffer layer and said at least two electrodes.

21. The electrooptic device of claim 13, wherein said electrooptic device is one of a single or a dual drive modulator.

22. The electrooptic device of claim 13, wherein a profile of said F⁻ ions determines one or more properties of said electrooptic device.

23. The electrooptic device of claim 13, wherein the substrate has a ridge configuration.

24. The electrooptic device of claim 13, wherein the substrate is made of one of LiNbO₃ or LiTaO₃.
